(19) United States
(12) Patent Application Publication
(10) Pub. No.: US 2006/0149581 A1
(43) Pub. Date: Jul. 6, 2006

(54) Method and system for aggregating data from various sources and forwarding it to end users

(76) Inventors: Edward G. Appel, Sewell, NJ (US); Thomas G. Masciocchi, Glendora, NJ (US)

Correspondence Address: SCHNADER HARRISON SEGAL & LEWIS, LLP, 1600 MARKET STREET, SUITE 3600, PHILADELPHIA, PA, 19103, US

(21) Appl. No.: 11/245,939

(22) Filed: Oct. 7, 2005

Related U.S. Application Data
(60) Provisional application No. 60/617,418, filed on Oct. 8, 2004.

(51) Int. Cl. G06Q 99/00

(52) U.S. Cl. 705/1

(57) ABSTRACT

A method and system for aggregating data from various sources that compiles data from public institutions, parses it according to system-defined and user-defined criteria, and transmits it to end users in a time sensitive manner. The data can be violations data, hearing data, and judgment data, and the data is transmitted to end user sellers of legal services in a timeframe during which the person to whom the violation, hearing, or judgment pertains would be in the market for legal counsel.

### PRIORITY

This application is based on, and claims priority to, provisional application having Ser. No. 60/617,418, having a filing date of Oct. 8, 2004, entitled Method and System for Aggregating Data from Various Sources and Forwarding it to End Users, the contents of which are incorporated herein by reference.

### FIELD OF THE INVENTION

The field of invention relates to database management, and more particularly to the creation and management of a database of data culled from various independent sources.

### BACK GROUND OF THE INVENTION

In the crowded media landscape of the early twenty-first century, it has become increasingly difficult for advertisers to get their messages to potential clients or customers. Personal technology gives individuals the ability to avoid advertising by avoiding the viewing of live television, in favor of recorded programs on digital video recorders, where individuals can easily skip or fast forward through commercial messages. On the Internet, advertising attempts are blocked by banner ad blockers, pop-up blockers, and the like. This has created more incentives for advertisers to make advertising more pervasive, and has created the feeling among potential customers that any advertising is an invasion of their privacy.

Advertisers attempt to combat this by targeting their advertising to the most possible receptive customers or clients. On the Internet, advertisers often use text documents and other tracking means such as “cookies,” saved on the hard drive of a computer user, which accumulate information about the user in an attempt to determine what types of advertising that user might be interested in viewing. Direct Mail companies also gather this type of information and use it in marketing. However, customers are often irritated by this sort of information gathering, especially when used to target them with advertising. As such, software exists to block the placement of cookies on user's computers, or to delete them from time to time, making them less effective.

That said, even in an anti-advertising culture, there are certain forms of advertising that potential customers are actually interested in viewing. It is extremely difficult for the advertiser to match up his advertising with a potential customer who has a desire to see it. An advertiser has substantial difficulty in obtaining information about potential clients that might be relevant to their desire to view specific types of advertising, and, even if such information is available, it is difficult to sort through it all and cull the truly relevant potential targets.

Public repositories of data exist that can be extremely relevant to the advertising of a certain type of product or service that relates to data that is legitimately collected by the government. For example, the government maintains records of persons having issues before its criminal or traffic courts, which can be relevant in the marketing of legal services. Because of the time-sensitive nature of these services, marketers need to identify advertising targets quickly, before the issues arise before the tribunal, or before the potential client retains counsel by alternate means.

Accordingly, a need exists therefore, for providing a method and system for accessing data sources and compiling the data from these sources in a format that is easily usable. Such an apparatus or method, when used by advertisers, would save the advertiser time and money by being able to target advertising to potential clients who would most likely be interested in it, and save the potential clients the hassle of receiving advertising that does not pertain to their needs and wants. If such an apparatus used data from a publicly available source, it would allow such targeted marketing without compromising the privacy of the potential clients. Additionally, a need exists for a method and apparatus for compiling the relevant marketing data in a timely fashion to enhance the target's receptiveness to the marketing.

### SUMMARY OF THE INVENTION

The foregoing needs are met, to a great extent, by the present invention, wherein in one aspect a method of compiling and distributing time-sensitive data comprising a plurality of records from an independent source is provided. The method comprises the steps of: receiving said time-sensitive data, uploading said data to a server, filtering said data to remove a portion of said plurality of records based on specified parameters to create a filtered data set, and making said filtered data set available to at least one customer during a predetermined time period. In a preferred embodiment, the independent source is a government repository of data, and the data comprises a first type of data from the group consisting of violations data, hearing data, and judgment data.

In one embodiment, the data comprises violations data having a violation date, and said predetermined period is measured from said violation date. In another embodiment, the data comprises hearing data, and the predetermined period is a predetermined number of days prior to the hearing. In another embodiment, the data comprises judgment data, and said predetermined period is a predetermined number of days after a date of entry of said judgment. In a preferred embodiment, the specified parameters comprise at least one user-specified parameter, which can include geographic parameters or violation types. In one embodiment, two users requesting data using the same parameters will receive different sets of data. In another embodiment, wherein each of the plurality of records comprises a name field, and the filtering step further comprises the steps of: searching an old filtered data set comprising an old plurality of records, determining whether the name field of one of the plurality of records equals an old record name field of one of the old plurality of records, and, if so, deleting the record from the data set.

In accordance with yet another embodiment of the present invention a method of compiling and distributing time sensitive data from a government data system is provided. The method comprises the steps of: receiving violations data from said government data system, the violations data comprising at least one record for an individual, the at least one record having a plurality of data fields comprising a name, an address, a violation type, violation date, and individual age information; creating a final data set comprising the steps of: searching the violations data to identify a duplicate record; if a duplicate record is identified, removing said duplicate record from the violations data; searching the individual age information of the at least one record to identify whether an age of said individual is less than a pre-determined age; if the age is less than the predetermined age, removing said at least one record from the violations data; identifying a non-desirable violation; searching the violation data to identify records where said violation type equals the non-desirable violation; and if the violation type equals the non-desirable violation, removing said record having the non-desirable violation from the violations data. The method can also make the final data set available to a customer, and may format the final data set before making it available to the customer.

In one embodiment of the invention, the plurality of data fields further comprises a record date field and step of making the final data set available to a customer occurs on a delivery date, the delivery date being less than one week after said record date. In another embodiment of the invention, method further comprises the steps of creating a filtered final data set comprising the steps of: providing at least one user-selectable criteria; receiving a request for said user-selectable criteria from said customer; searching said plurality of data fields of the at least one record for said criteria; if said criteria is met, including said record in the filtered data set; and repeating the searching said plurality of data fields step and the including said record step until all of said violations data has been searched; and making the filtered final data set available to a customer. Such a method can be performed using hearing data or judgment data in lieu of or in addition to violation data.

In another embodiment of the invention, a system is provided containing means for performing the various methods of the various embodiments of the inventive method. In yet another embodiment of the invention, a computer readable medium is provided containing data produced by the various embodiments of the inventive method.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The present invention provides methods and systems for aggregating data from various sources and forwarding data to end users. Preferred embodiments of the invention and variations thereof are described in the accompanying drawings, in which like reference numerals indicate like elements.

FIG. 1 depicts the first part of a flowchart of the preferred embodiment in accordance with the present invention.

FIG. 2 depicts the second part of a flowchart of the preferred embodiment in accordance with the present invention.

FIG. 3 depicts the architecture of a system embodiment in accordance with the present invention.

FIG. 4 depicts the user interface embodiment in accordance with the present invention.

### DETAILED DESCRIPTION OF THE PREFERRED EMBODIMENT

The general features of a number of embodiments of the present invention having been generally set forth, a detailed description of the preferred embodiment of the present invention will be set forth, with reference to the accompanying drawings. The assignee of this invention uses the website for Courtlist.com, which gathers and prepares information for legal and other professionals seeking potential clients. References herein to Courtlist.com are for exemplary purposes only, and persons of ordinary skill will recognize that the present invention is not limited to the specific implementation of Courtlist.com, and can be implemented by one or more entities other than Courtlist.com.

According to one embodiment of the invention, various sources of data are accessed preferably electronically but sometimes manually. Accessing the data involves establishing communication between one or more computers and the various sources of data. This is preferably done via a web site, but can also be done via cable modem, phone modem or wireless communication, or any other protocol for data communication known to persons of ordinary skill. This data is then captured by Courtlist.com via data mining computer programming and scripting that extrapolates customer desireable date, for example, the names and other information related to individuals, preferably related to offenders and associated offenses. Herein, such individuals are referred to using terms such as “offender,” “potential client,” “target,” and the like, and such terms are used interchangeably to mean a person toward whom a user of the present invention may wish to market his or her goods or services. Customers preferably may include marketers or more specifically providers of legal and other services. The names and other information are transmitted to the customers at Courtlist.com in a timely fashion to ensure that the services offered to the customers of Courtlist.com would still be useful to the offender.

For example, a customer may request a compilation of individuals who have recently been cited for a traffic violation from the appropriate source, typically a state's court's administrative office. In response to such a request, the data relating to such individuals is compiled electronically on a daily basis. The data is then transmitted electronically to customers of Courtlist.com for direct mailing advertising purposes. Alternatively and/or in addition, data regarding individuals who have a court hearing approaching within the next several days can also be requested, obtained, filtered, and transmitted. The data is time sensitive because a potential marketing target may have a hearing in the very near future, or may look quickly to obtain counsel for a violation for which the target was recently cited. Alternatively, a potential target may have had a judgment issued against him in the recent past, and may require legal representation in consideration of that judgment. As such, the Courtlist.com system receives, processes, and transmits relevant data within a period of a few days or a few weeks.

Customers are able to use the web site provided by Courtlist.com to make user-selectable requests for their orders or employ other electronic or manual methods to make such a request. For example, lawyers interested in criminal/traffic violators could access Courtlist.com to specify their geographical area of interest and the amount of data they are requesting. The geographical areas of interest are preferably broken down into regions, locales, names of courts, and the like.

To minimize competition and to maintain the attractiveness of Courtlist.com's services, the present invention may comprise steps to limit the number of customers who desire a specific geographical area of interest for the collection of the data.

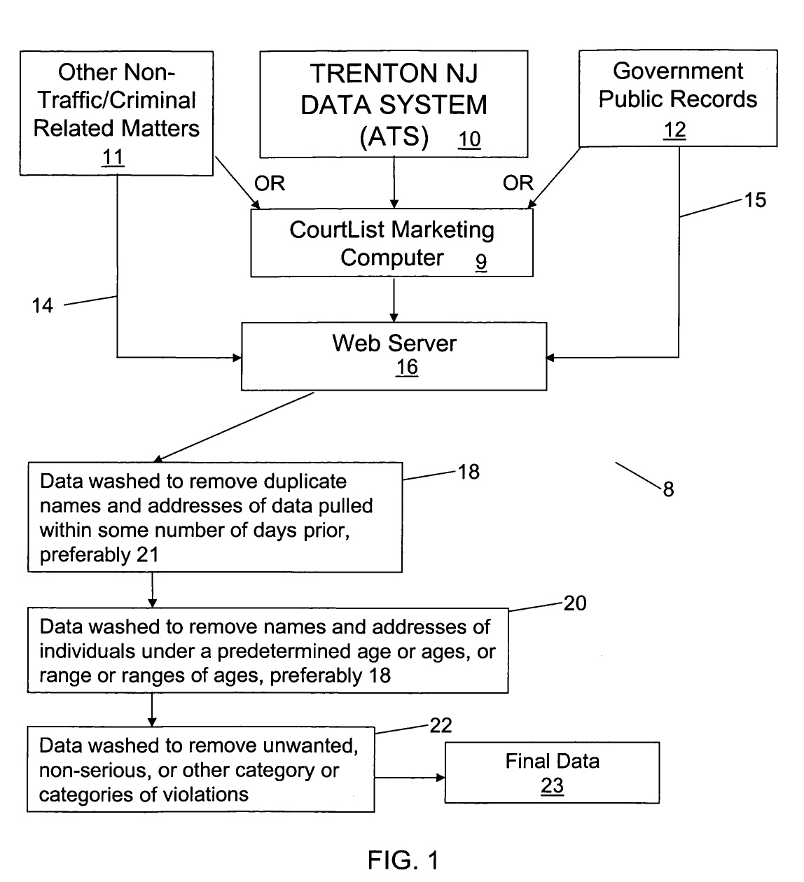

Turning now to FIG. 1, the method 8 of the present invention is depicted. The method 4 comprises at least one computer receives data from one or more outside sources. The data preferably relates to information about persons having business before a state or local government agency or court, including criminal matters and/or traffic matters. In the example of the preferred embodiment shown here, the computer 9 receives data directly from Trenton N.J. Data System 10 via a scripting program or the like. The computer 5 may also receive data related to Other Non-Traffic/Criminal Related Matters 11 and Government Public Records 12. This receipt of data from the data sources can be accomplished using a “pull” method, where the database system polls the data source for new information, or a “push” method where a system at the data source sends the information to the system. However, it should be understood that the invention is not limited by these two methods and that, for example, data may be transferred from one computer server to another with or without manual intervention. Alternatively or in addition, data can be obtained from an outside source and then manually entered into the computer 5, or to the web server 16 as shown in steps 14 and 15 described in greater detail below.

After the data is received, it is uploaded to the Courtlist.com server 16, either manually or through an automatic process. In a preferred embodiment, the data can be “washed” to remove unwanted records, as illustrated, for example, by data washing step 18. Washing can be accomplished using a filtering process that searches certain fields of each record for predetermined criteria. As shown in step 18, in this embodiment, information is removed from the data if such information contains a name field that matches the name field of another record that had been added to the system within a predetermined number of days, preferably within twenty-one days.

The data can be filtered further to remove records of individuals within a certain age range. For example, in step 20, the data is washed to remove records of individuals below a certain age, preferably eighteen years old. Information and records can also be removed from the data if the offense or matter before the government agency or court is not of a type that is desired by the system. For example, in step 22, data is washed to remove non-serious violations, such as for example seatbelt violations, parking tickets, violations carrying no Division of Motor Vehicle points or serious consequences and the like.

Once the data is sufficiently washed according to one or more embodiments of the invention, the final data 23 is then made available for distribution and/or sale.

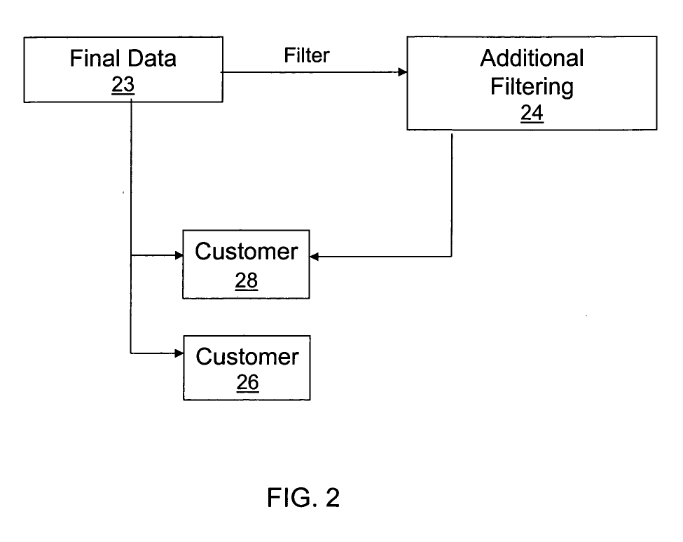

Turning now to FIG. 2, which is continuation of the chart shown in FIG. 1, the final data 23 may be further filtered according to “user-selectable” or “customer-selectable” criteria. For example, as illustrated in step 24, Courtlist.com customers can choose the types of data they wish to receive by requesting data about individuals charged with a particular type or category of offenses or violations, such as drunk driving, traffic violations and the like. According to other preferred embodiments of the invention, other user-selectable criteria can be made available to filter the data by one or more of the following: court, government agency, court county, court I.D. number, geographic region of the offender, race, sex, age, or nature of violation.

According to one embodiment of the invention, once the data has been filtered into final data 23, it is transmitted to a customer 26 as shown in step 27, preferably in response to a customer order. In another embodiment, final data 23 is further filtered in step 24 according to customer-selectable criteria before being transmitted to a customer 28. The data received by a customer can be sent via fax or electronic mail, made available for download via the internet, or may be transmitted via any other paper or electronic distribution mechanism. The data may be pre-formatted before it is transmitted to customer 26 or customer 28. For example, after the final data 23 is gathered, the data can be converted into a delimited text format, for example. Formatting the data may assist customers in their use of such data. For example, a customer may wish to use the data it receives to create individual advertising or promotional pieces for each record. Providing the data in a comma delimited format assists and/or streamlines this process. Other customers may prefer to use the data, at least in part, to print address labels. Providing the data in a ready-made mailing label format meets this need. It should be understood that embodiments of the invention that pre-format the data are not limited to the delimited text format and mailing label format. Persons of ordinary skill will recognize that other data formats can also be used. In a preferred embodiment, the system maintains a logging system to record the times at which data is sent to a customer.

Customers are able to choose their criteria and the number of records they wish to purchase. Customers may desire that their data be different than the data sold to other customers with whom they are competing. In a preferred embodiment, the data is randomized so that two customers requesting a certain number of names with matters pending before a particular court receive two different lists, so that each may have a somewhat more exclusive opportunity to market their services to the person whose information appears in the record.

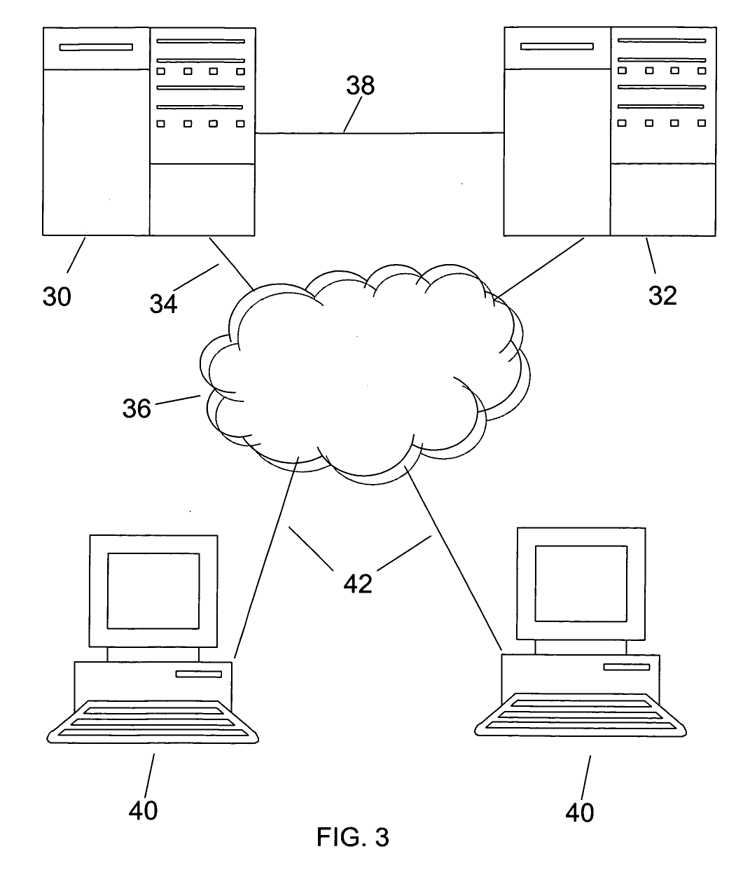

Turning now to FIG. 3, a system 50 embodying the present invention is shown. This system 50 depicts an exemplary architecture of the courtlist.com system. However, persons of ordinary skill will realize that alternative architectures are possible. The courtlist.com server 30 is connected to a government server or data store 32, either via a link 34 to the internet 36, or a direct communications link 38 or the like. Persons of ordinary skill will realize that the courtlist.com system can include a plurality of servers as opposed to a single server as illustrated, such servers performing various functions including obtaining data, parsing data, compiling data, providing a web interface, or any of the other functions or methods described herein. The phrase “a server” thus refers to a single server or to a plurality of servers. The servers 30, should more than one be used, can be directly connected to each other in a local area network or other private network, or connected to each other via the internet Persons of ordinary skill will also realize that although only one government computer is depicted, the system can interface with multiple systems from multiple governments or other data sources, all connected either via the internet or via a direct connection. Customers' computers 40 can connect to courtlist.com via links 42 to the internet 36, or can connect to their e-mail, can have data e-mailed to them via the internet, via arranging other suitable means for transferring data.

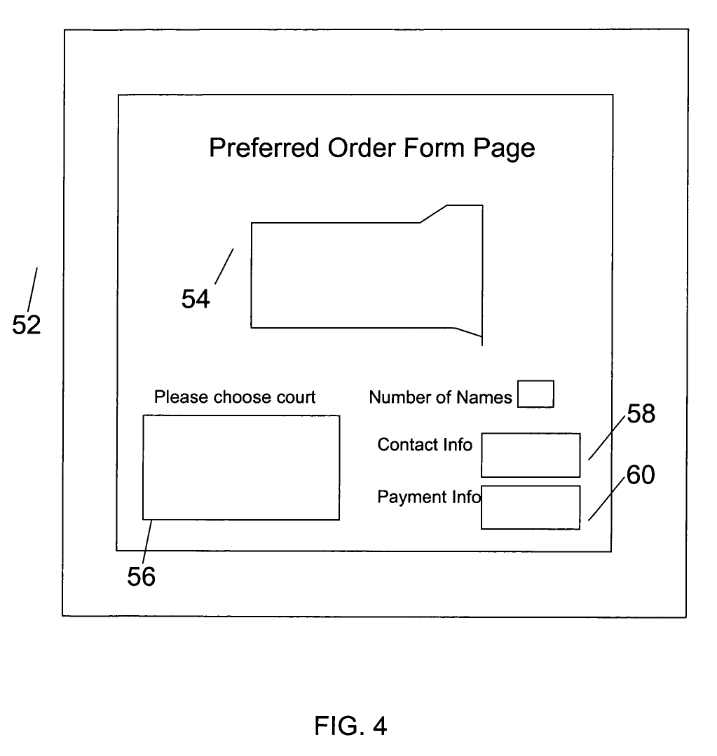

Turning now to FIG. 4, a preferred embodiment of the invention comprises a web-site where a customer can use a user interface to select customer-selectable criteria. The user interface includes a “Preferred Order Form Page” 52, which identifies all courts by name, address and county—as well as an I.D. number, and shows a map broken down by county within a state or commonwealth 54. In a preferred embodiment, if a user selects a particular county, the user is provided with a list of all Municipal Courts in that county 56. The user interface also includes a price list and an order form. The Order Form asks the user to set forth contact information 58, including, preferably, his full name, address, telephone number, fax number. The Order Form then asks user to place payment information 60, such as Credit Card name, account number, expiration date, name as it appears on the card, and billing address. All of this information is stored and obtained using web pages and servers in a secured format.

The user is then asked to select the court(s) from which he desires a list, and a number of names he desires to purchase, including the entire list. In a preferred embodiment, the user is informed that it will be provided with names from these Court(s) until the number is reached. The user may be informed when or over what time period hearings will occur for such names. Preferably, the time period is 10 to 60 days in the future.

Other aspects of the web-site not shown in FIG. 4 include a home page that describes the service and lists contact numbers, methods of becoming a member, and payment options. Another page, which is delivered in a secured format, takes payment information from a customer and accepts credit cards such as Visa, Mastercard, and American Express, as well as alternate methods of payment such as Paypal.

In a preferred embodiment, the customer is advised that membership fees are processed on a monthly basis and automatically renewed. However the invention is not so limited and may contemplate any billing and/or billing notice scheme.

The customer may select the frequency of which it desires to purchase names. For example, the customer can purchase an equal number of names daily (days/week)—weekly (every 7^{th} day from initial order) or other frequency. The customer is advised via the web-site that his order will be processed at eh same frequency until it cancels or changes such order request. Preferably, the user is advised that orders will not be processed if membership fees are not maintained or billing fails. Once placing the order, the user may be asked to confirm orders.

A preferred embodiment may also include a cancellation page, and an order change page with a hyperlink back to an order form. On the order change page, the user is advised that the new requests will be used and processed on all future orders until cancellation or additional modification.

The inventive methods and devices are particularly applicable to gathering data and distributing useful data to legal practitioners, however, application to other database gathering and preparation for time sensitive marketing is within the spirit and scope of the invention.

The invention includes the methods described herein and systems and apparatus for carrying out such methods. The invention further includes integrated circuits and computer chips incorporating the devices, systems and machines configured to run software implementing the methods, and a computer readable medium containing software for implementing the methods.

While the invention has been described by illustrative embodiments, additional advantages and modifications will occur to those skilled in the art. Therefore, the invention in its broader aspects is not limited to specific details shown and described herein, but should be interpreted within the full spirit and scope of the appended claims and their equivalents.

What is claimed is:

1. A method of compiling and distributing time-sensitive data comprising a plurality of records from an independent source, the method comprising the steps of:
receiving said time-sensitive data;
uploading said data to a server;
filtering said data to remove a portion of said plurality of records based on specified parameters to create a filtered data set; and
making said filtered data set available to at least one customer during a selected time period.

2. The method of claim 1, wherein said independent source is a government repository of data, and said data comprises a first type of data from the group consisting of violations data, hearing data, and judgment data.

3. The method of claim 1, wherein said data comprises violations data having a violation date, and said selected period is measured from said violation date.

4. The method of claim 1, wherein said data comprises hearing data, and said selected period is a number of days prior to said hearing.

5. The method of claim 1, wherein said data comprises judgment data, and said selected period is a number of days after a date of entry of said judgment.

6. The method of claim 1, wherein said specified parameters comprise at least one user-specified parameter.

7. The method of claim 6, wherein at least one of said user-specified parameters comprises a geographic parameter.

8. The method of claim 6, wherein at least one of said user-specified parameters comprises a type of violation.

9. The method of claim 6, wherein the at least one customer comprises a first customer and a second customer, and the filtering step further comprises the steps of:
receiving a user-specified parameter from the first customer;
receiving the user-specified parameter from the second customer;
creating a first filtered data for said first customer, and a second filtered data set for said second customer, wherein said second filtered data set contains at least one of said plurality of records that is not contained in said first filtered data set.

10. The method of claim 1, wherein each of said plurality of records comprises a name field, and wherein said filtering step further comprises the steps of:
searching an old filtered data set comprising an old plurality of records, determining whether the name field of one of the plurality of records equals an old record name field of one of the old plurality of records, and, if so, deleting said record from said data set.

11. The method of claim 1, wherein said filtering step comprises the step of removing records from said data set wherein an age of an individual to whom a record pertains is less than a certain number.

12. A method of compiling and distributing time sensitive data from a government data system comprising the steps of:
receiving violations data from said government data system, the violations data comprising at least one record for an individual, the at least one record having a plurality of data fields comprising a name, an address, a violation type, violation date, and individual age information;
creating a final data set comprising the steps of:
searching the violations data to identify a duplicate record;
if a duplicate record is identified, removing said duplicate record from the violations data;
searching the individual age information of the at least one record to identify whether an age of said individual is less than a pre-determined age;
if the age is less than the predetermined age, removing said at least one record from the violations data;
identifying a non-desirable violation;
searching the violation data to identify records where said violation type equals the non-desirable violation; and
if the violation type equals the non-desirable violation, removing said record having the non-desirable violation from the violations data.

13. The method of claim 12 further comprising the step of making the final data set available to a customer.

14. The method of claim 13 comprising the step of formatting the final data set before the step of making the final data set available to the customer.

15. The method of claim 13 wherein the plurality of data fields further comprises a record date field and step of making the final data set available to a customer occurs on a delivery date, said delivery date being less than one week after said record date.

16. The method of claim 12 further comprising the steps of:
creating a filtered final data set comprising the steps of:
providing at least one user-selectable criteria;
receiving a request for said user-selectable criteria from said customer;
searching said plurality of data fields of the at least one record for said criteria;
if said criteria is met, including said record in the filtered data set; and
repeating the searching said plurality of data fields step and the including said record step until all of said violations data has been searched; and
making the filtered final data set available to a customer.

17. A method of compiling and distributing time sensitive data from a government data system comprising the steps of:
receiving hearing data from said government data system, the hearing data comprising at least one record for an individual, the at least one record having a plurality of data fields comprising a name, an address, a violation type, hearing date, and individual age information;
creating a final data set comprising the steps of:
searching the hearing data to identify a duplicate record;
if a duplicate record is identified, removing said duplicate record from the hearing data;
searching the individual age information of the at least one record to identify whether an age of said individual is less than a pre-determined age;
if the age is less than the predetermined age, removing said at least one record from the hearing data;
identifying a non-desirable violation;
searching the hearing data to identify records where said violation type equals the non-desirable violation; and
if the violation type equals the non-desirable violation, removing said record having the non-desirable violation from the hearing data.

18. The method of claim 17 further comprising the step of making the final data set available to a customer.

19. The method of claim 18 comprising the step of formatting the final data set before the step of making the final data set available to the customer.

20. The method of claim 18 wherein the plurality of data fields further comprises a record date field and step of making the final data set available to a customer occurs on a delivery date, said delivery date being less than one week after said record date.

21. The method of claim 17 further comprising the steps of:
creating a filtered final data set comprising the steps of:
providing at least one user-selectable criteria;
receiving a request for said user-selectable criteria from said customer;
searching said plurality of data fields of the at least one record for said criteria;
if said criteria is met, including said record in the filtered data set; and
repeating the searching said plurality of data fields step and the including said record step until all of said violations data has been searched; and
making the filtered final data set available to a customer.

22. A method of compiling and distributing time sensitive data from a government data system comprising the steps of:
receiving judgment data from said government data system, the judgment data comprising at least one record for an individual, the at least one record having a plurality of data fields comprising a name, an address, a violation type, judgment date, and individual age information;
creating a final data set comprising the steps of:
searching the judgment data to identify a duplicate record;
if a duplicate record is identified, removing said duplicate record from the judgment data;
searching the individual age information of the at least one record to identify whether an age of said individual is less than a pre-determined age;
if the age is less than the predetermined age, removing said at least one record from the judgment data;
identifying a non-desirable violation;
searching the judgment data to identify records where said violation type equals the non-desirable violation; and
if the violation type equals the non-desirable violation, removing said record having the non-desirable violation from the judgment data.

23. The method of claim 22 further comprising the step of making the final data set available to a customer.

24. The method of claim 23 comprising the step of formatting the final data set before the step of making the final data set available to the customer.

25. The method of claim 23 wherein the plurality of data fields further comprises a record date field and step of making the final data set available to a customer occurs on a delivery date, said delivery date being less than one week after said record date.

26. The method of claim 22 further comprising the steps of:
creating a filtered final data set comprising the steps of:
providing at least one user-selectable criteria;
receiving a request for said user-selectable criteria from said customer;
searching said plurality of data fields of the at least one record for said criteria;
if said criteria is met, including said record in the filtered data set; and
repeating the searching said plurality of data fields step and the including said record step until all of said violations data has been searched; and
making the filtered final data set available to a customer.

27. A computer system of compiling and distributing time sensitive data from a government data system, said computer system comprising a server, wherein said server comprises:
hardware and software for receiving violations data from said government data system, the violations data comprising at least one record for an individual, the at least one record having a plurality of data fields comprising a name, an address, a violation type, violation date, and individual age information;
software for creating a final data set comprising:
software for searching the violations data to identify a duplicate record; and if a duplicate record is identified, removing said duplicate record from the violations data;
software for searching the individual age information of the at least one record to identify whether an age of said individual is less than a pre-determined age; and if the age is less than the predetermined age, removing said at least one record from the violations data; and
software for identifying a non-desirable violation, searching the violation data to identify records where said violation type equals the non-desirable violation; and if the violation type equals the non-desirable violation, removing said record having the non-desirable violation from the violations data.

28. The system of claim 27, wherein said server further comprises hardware and software for making the final data set available to a customer.

29. The system of claim 28, wherein said server further comprises software for formatting the final data set before the step of making the final data set available to the customer.

30. The system of claim 28, wherein said server further comprises
software for creating a filtered final data set comprising:
software for providing at least one user-selectable criteria;
software for receiving a request for said user-selectable criteria from said customer;
searching software for searching said plurality of data fields of the at least one record for said criteria; and if said criteria is met, including said record in the filtered data set; and
software for repeatedly activating the searching software until all of said violations data has been searched; and
software for making the filtered final data set available to a customer.

31. The system of claim 27 wherein the plurality of data fields further comprises a record date field and step of making the final data set available to a customer occurs on a delivery date, said delivery date being less than one week after said record date.

32. A computer system of compiling and distributing time sensitive data from a government data system, said computer system comprising a server, wherein said server comprises:
hardware and software for receiving hearing data from said government data system, the hearing data comprising at least one record for an individual, the at least one record having a plurality of data fields comprising a name, an address, a violation type, hearing date, and individual age information;
software for creating a final data set comprising:
software for searching the hearing data to identify a duplicate record; and if a duplicate record is identified, removing said duplicate record from the hearing data;
software for searching the individual age information of the at least one record to identify whether an age of said individual is less than a pre-determined age; and if the age is less than the predetermined age, removing said at least one record from the hearing data; and
software for identifying a non-desirable violation, searching the violation data to identify records where said violation type equals the non-desirable violation; and if the violation type equals the non-desirable violation, removing said record having the non-desirable violation from the hearing data.

33. The system of claim 32, wherein said server further comprises hardware and software for making the final data set available to a customer.

34. The system of claim 33 wherein said server further comprises software for formatting the final data set before the step of making the final data set available to the customer.

35. The system of claim 33 wherein said server further comprises
software for creating a filtered final data set comprising:
software for providing at least one user-selectable criteria;
software for receiving a request for said user-selectable criteria from said customer;
searching software for searching said plurality of data fields of the at least one record for said criteria; and if said criteria is met, including said record in the filtered data set; and
software for repeatedly activating the searching software until all of said hearing data has been searched; and
software for making the filtered final data set available to a customer.

36. The system of claim 32 wherein the plurality of data fields further comprises a record date field and step of making the final data set available to a customer occurs on a delivery date, said delivery date being less than one week after said record date.

37. A computer system of compiling and distributing time sensitive data from a government data system, said computer system comprising a server, wherein said server comprises:
hardware and software for receiving judgment data from said government data system, the judgment data comprising at least one record for an individual, the at least one record having a plurality of data fields comprising a name, an address, a violation type, judgment date, and individual age information;
software for creating a final data set comprising:
software for searching the judgment data to identify a duplicate record; and if a duplicate record is identified, removing said duplicate record from the judgment data;
software for searching the individual age information of the at least one record to identify whether an age of said individual is less than a pre-determined age; and if the age is less than the predetermined age, removing said at least one record from the judgment data; and
software for identifying a non-desirable violation, searching the violation data to identify records where said violation type equals the non-desirable violation; and if the violation type equals the non-desirable violation, removing said record having the non-desirable violation from the judgment data.

38. The system of claim 37 wherein said server further comprises hardware and software for making the final data set available to a customer.

39. The system of claim 38 wherein said server further comprises software for formatting the final data set before the step of making the final data set available to the customer.

40. The system of claim 38 further comprising
software for creating a filtered final data set comprising:
software for providing at least one user-selectable criteria;
software for receiving a request for said user-selectable criteria from said customer;
searching software for searching said plurality of data fields of the at least one record for said criteria; and if said criteria is met, including said record in the filtered data set; and
software for repeatedly activating the searching software until all of said judgment data has been searched; and
software for making the filtered final data set available to a customer.

41. The system of claim 37 wherein the plurality of data fields further comprises a record date field and step of making the final data set available to a customer occurs on a delivery date, said delivery date being less than one week after said record date.

42. A computer readable medium comprising data compiled using a method of compiling and distributing time sensitive data from a government data system, said method comprising the steps of:
receiving violations data from said government data system, the violations data comprising at least one record for an individual, the at least one record having a plurality of data fields comprising a name, an address, a violation type, violation date, and individual age information;
creating a final data set comprising the steps of:
searching the violations data to identify a duplicate record;
if a duplicate record is identified, removing said duplicate record from the violations data;
searching the individual age information of the at least one record to identify whether an age of said individual is less than a pre-determined age;
if the age is less than the predetermined age, removing said at least one record from the violations data;
identifying a non-desirable violation;
searching the violation data to identify records where said violation type equals the non-desirable violation; and
if the violation type equals the non-desirable violation, removing said record having the non-desirable violation from the violations data.

43. The medium of claim 42, wherein said method further comprises the step of making the final data set available to a customer.

44. The medium of claim 43, wherein said method further comprises the step of formatting the final data set before the step of making the final data set available to the customer.

45. The medium of claim 43 wherein the plurality of data fields further comprises a record date field and step of making the final data set available to a customer occurs on a delivery date, said delivery date being less than one week after said record date.

46. The medium of claim 42, wherein said method further comprises the steps of:
creating a filtered final data set comprising the steps of:
providing at least one user-selectable criteria;
receiving a request for said user-selectable criteria from said customer;
searching said plurality of data fields of the at least one record for said criteria;
if said criteria is met, including said record in the filtered data set; and
repeating the searching said plurality of data fields step and the including said record step until all of said violations data has been searched; and
making the filtered final data set available to a customer.

47. A computer readable medium comprising data compiled using a method of compiling and distributing time sensitive data from a government data system, said method comprising the steps of:
receiving hearing data from said government data system, the hearing data comprising at least one record for an individual, the at least one record having a plurality of data fields comprising a name, an address, a violation type, hearing date, and individual age information;
creating a final data set comprising the steps of:
searching the hearing data to identify a duplicate record;
if a duplicate record is identified, removing said duplicate record from the hearing data;
searching the individual age information of the at least one record to identify whether an age of said individual is less than a pre-determined age;
if the age is less than the predetermined age, removing said at least one record from the hearing data;
identifying a non-desirable violation;
searching the hearing data to identify records where said violation type equals the non-desirable violation; and
if the violation type equals the non-desirable violation, removing said record having the non-desirable violation from the hearing data.

48. The medium of claim 47 wherein said method further comprises the step of making the final data set available to a customer.

49. The medium of claim 48 wherein said method further comprises the step of formatting the final data set before the step of making the final data set available to the customer.

50. The medium of claim 48 wherein the plurality of data fields further comprises a record date field and step of making the final data set available to a customer occurs on a delivery date, said delivery date being less than one week after said record date.

51. The medium of claim 47 wherein said method further comprises the steps of:
creating a filtered final data set comprising the steps of:
providing at least one user-selectable criteria;
receiving a request for said user-selectable criteria from said customer;
searching said plurality of data fields of the at least one record for said criteria;
if said criteria is met, including said record in the filtered data set; and
repeating the searching said plurality of data fields step and the including said record step until all of said violations data has been searched; and
making the filtered final data set available to a customer.

52. A computer readable medium comprising data compiled using a method of compiling and distributing time sensitive data from a government data system, said method comprising the steps of:
receiving judgment data from said government data system, the judgment data comprising at least one record for an individual, the at least one record having a plurality of data fields comprising a name, an address, a violation type, judgment date, and individual age information;
creating a final data set comprising the steps of:
searching the judgment data to identify a duplicate record;
if a duplicate record is identified, removing said duplicate record from the judgment data;
searching the individual age information of the at least one record to identify whether an age of said individual is less than a pre-determined age;
if the age is less than the predetermined age, removing said at least one record from the judgment data;
identifying a non-desirable violation;
searching the judgment data to identify records where said violation type equals the non-desirable violation; and
if the violation type equals the non-desirable violation, removing said record having the non-desirable violation from the judgment data.

53. The medium of claim 52 wherein said method further comprises the step of making the final data set available to a customer.

54. The medium of claim 53 wherein said method further comprises the step of formatting the final data set before the step of making the final data set available to the customer.

55. The medium of claim 53 wherein the plurality of data fields further comprises a record date field and step of making the final data set available to a customer occurs on a delivery date, said delivery date being less than one week after said record date.

56. The medium of claim 52 wherein said method further comprises the steps of:
creating a filtered final data set comprising the steps of:
providing at least one user-selectable criteria;
receiving a request for said user-selectable criteria from said customer;
searching said plurality of data fields of the at least one record for said criteria;
if said criteria is met, including said record in the filtered data set; and
repeating the searching said plurality of data fields step and the including said record step until all of said violations data has been searched; and
making the filtered final data set available to a customer.
